(19) United States
(12) Patent Application Publication
(10) Pub. No.: US 2026/0171040 A1
(43) Pub. Date: Jun. 18, 2026

(54) LIQUID CRYSTAL DISPLAY DEVICE AND DRIVING METHOD THEREOF

(71) Applicant: Iris Optronics Co., Ltd., Tainan City (TW)

(72) Inventors: Ting Yu TAI, Tainan City (TW); Wu Chang YANG, Tainan City (TW); Chi Chang LIAO, Tainan City (TW)

(21) Appl. No.: 19/390,677

(22) Filed: Nov. 17, 2025

Related U.S. Application Data
(60) Provisional application No. 63/721,554, filed on Nov. 17, 2024.

(51) Int. Cl. G09G 3/36; G09G 3/20

(52) U.S. Cl. CPC G09G 3/3644; G09G 3/2085; G09G 2310/08; G09G 2320/0242

(57) ABSTRACT

A liquid crystal display device is proposed, and includes a display panel, a timing control module, and a plurality of driving modules. The display panel includes a plurality of display blocks. The timing control module is configured to simultaneously generate a plurality of timing control signals. The driving modules are connected between the timing control module and the display panel, and receive the timing control signals, respectively. At least one of the driving modules outputs a plurality of scan signal groups to the display blocks according to at least one of the timing control signals. The driving modules respectively output a plurality of data signal groups to the display blocks according to the timing control signals, causing the display blocks to be driven by the scan signal groups and the data signal groups to display an image.

### RELATED APPLICATIONS

This application claims priority to U.S. Provisional Application Ser. No. 63/721,554, filed Nov. 17, 2024, which is herein incorporated by reference.

### BACKGROUND

### Technical Field

The present disclosure relates to a liquid crystal display device and a driving method thereof. More particularly, the present disclosure relates to a cholesteric liquid crystal display device with short imaging time and a driving method thereof.

### Description of Related Art

Existing cholesteric liquid crystal displays (ChLCDs) have the advantage of low power consumption. However, they suffer from the drawback of slow imaging speed (i.e., long imaging time), and thus are unable to present images (or screens) in a real-time and rapid manner. As a result, the viewing experience of users is easily affected, making ChLCDs difficult to apply to dynamic image display applications and limiting their use primarily to static display.

Various driving schemes have been developed for ChLCDs, such as dynamic drive scheme (DDS) having a relatively faster driving speed and pulse-width modulation (PWM) drive scheme having a relatively slower driving speed. Each of the aforementioned driving schemes has its own advantages and disadvantages. For example, DDS has a relatively narrow operating window, which makes it difficult to precisely control the chromaticity of the cholesteric liquid crystal. In addition, DDS is susceptible to environmental conditions (such as temperature), material characteristics and driving conditions, resulting in unsatisfactory color performance of the formed images. Although PWM driving scheme can significantly alleviate the issues associated with DDS, its imaging time still fails to meet the requirements for dynamic image display. Consequently, products requiring a short image formation time may not be suitable for practical use. Accordingly, there is currently a lack of a ChLCD and a driving method thereof that are capable of achieving fast imaging speed, and related industries are actively seeking solutions to address this problem.

### SUMMARY

According to one aspect of the present disclosure, a liquid crystal display device includes a display panel, a timing control module and a plurality of driving modules. The display panel includes a plurality of display blocks. The timing control module is configured to simultaneously generate a plurality of timing control signals. The driving modules are connected between the timing control module and the display panel, and respectively receive the timing control signals. At least one of the driving modules outputs a plurality of scan signal groups to the display blocks according to at least one of the timing control signals. The driving modules respectively output a plurality of data signal groups to the display blocks according to the timing control signals, causing the display blocks to be driven by the scan signal groups and the data signal groups to display an image.

According to another aspect of the present disclosure, a driving method of a liquid crystal display device is for driving the liquid crystal display device. The liquid crystal display device includes a display panel, a timing control module and a plurality of driving modules, and the display panel includes a plurality of display blocks. The driving method of the liquid crystal display device includes simultaneously generating, by the timing control module, a plurality of timing control signals; respectively receiving, by the driving modules, the timing control signals; outputting, by at least one of the driving modules, a plurality of scan signal groups to the display blocks according to at least one of the timing control signals; and respectively outputting, by the driving modules, a plurality of data signal groups to the display blocks according to the timing control signals, causing the display blocks to be driven by the scan signal groups and the data signal groups to display an image.

### BRIEF DESCRIPTION OF THE DRAWINGS

FIG. 1 is a schematic diagram illustrating a liquid crystal display device according to a first embodiment of the present disclosure.

FIG. 2 is a schematic diagram illustrating a display panel, a first driving module and a second driving module in the liquid crystal display device of FIG. 1.

FIG. 3A is a timing diagram illustrating a scan signal in a conventional ChLCD.

FIG. 3B is a timing diagram illustrating a scan signal in the liquid crystal display device of FIG. 1.

FIG. 4 is a schematic diagram illustrating a display panel, a first driving module and a second driving module of a liquid crystal display device according to a second embodiment of the present disclosure.

FIG. 5 is a schematic diagram illustrating a display panel, a first driving module and a second driving module of a liquid crystal display device according to a third embodiment of the present disclosure.

FIG. 6 is a schematic diagram illustrating a display panel, a first driving module and a second driving module of a liquid crystal display device according to a fourth embodiment of the present disclosure.

FIG. 7 is a schematic diagram illustrating a display panel, a first driving module and a second driving module of a liquid crystal display device according to a fifth embodiment of the present disclosure.

FIG. 8 is a schematic diagram illustrating a display panel, a first driving module and a second driving module of a liquid crystal display device according to a sixth embodiment of the present disclosure.

FIG. 9 is a schematic diagram illustrating a display panel, a first driving module and a second driving module of a liquid crystal display device according to a seventh embodiment of the present disclosure.

FIG. 10 is a schematic diagram illustrating a display panel, a first driving module and a second driving module of a liquid crystal display device according to an eighth embodiment of the present disclosure.

FIG. 11 is a flowchart illustrating a driving method of a liquid crystal display device according to a ninth embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected” to another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

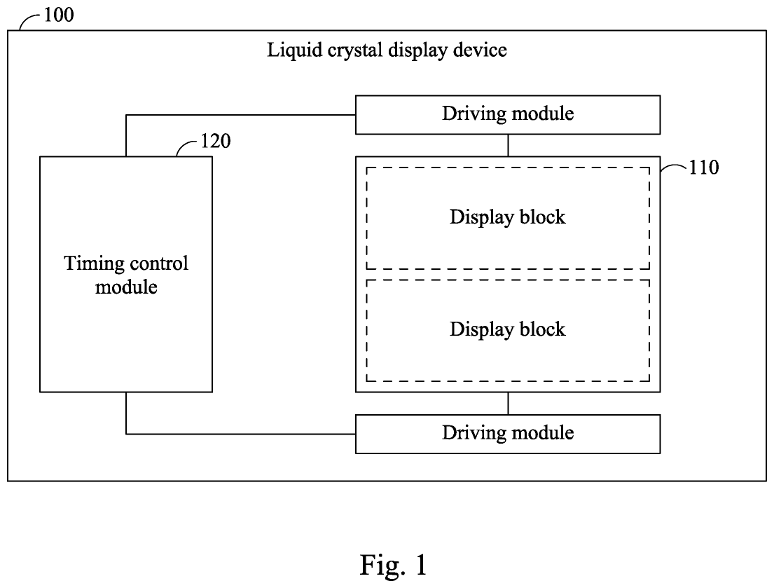

Please refer to FIG. 1. FIG. 1 is a schematic diagram illustrating a liquid crystal display device 100 according to a first embodiment of the present disclosure. As shown in FIG. 1, the liquid crystal display device 100 includes a display panel 110, a timing control module 120 and a plurality of driving modules (its reference numeral is omitted). The display panel 110 includes a plurality of display blocks (its reference numeral is omitted). The timing control module 120 is configured to simultaneously generate a plurality of timing control signals. The driving modules are signally connected between the timing control module 120 and the display panel 110, and respectively receive the timing control signals. At least one of the driving modules outputs a plurality of scan signal groups to the display blocks according to at least one of the timing control signals (i.e., the corresponding received timing control signal), and the driving modules respectively output a plurality of data signal groups to the display blocks according to the timing control signals, causing the display blocks to be driven by the scan signal groups and the data signal groups to display an image (or a screen). Therefore, the liquid crystal display device 100 of the present disclosure utilizes independent scan signal groups and independent data signal groups to simultaneously, or with a slight time difference, perform multi-block driving and imaging, thereby shortening an overall imaging time required for the display panel 110 to display the image, and thus enabling application to dynamic image display. The numbers of the display blocks and the driving modules shown in FIG. 1 are merely illustrative, and the present disclosure is not limited thereto.

In some embodiments, the timing control module 120 can be a timing controller (TCON), which receives an image signal from an external device (not shown) and converts the image signal into signal formats and timing commands required for driving the display panel 110. The primary function of the timing control module 120 is to convert the image signal and synchronously transmit the converted signal to each of the driving modules so as to ensure that the display panel 110 properly displays images. Each of the driving modules can include at least one driver integrated circuit (driver IC). Timings of the scan signals and the data signals output from the driver ICs are controlled by the timing control signals generated by the timing controller. In addition, when a driving module is composed of a plurality of driver ICs, timings of the plurality of scan signals and the plurality of data signals output from the driver ICs can be synchronized according to the timing control signals generated by the timing controller.

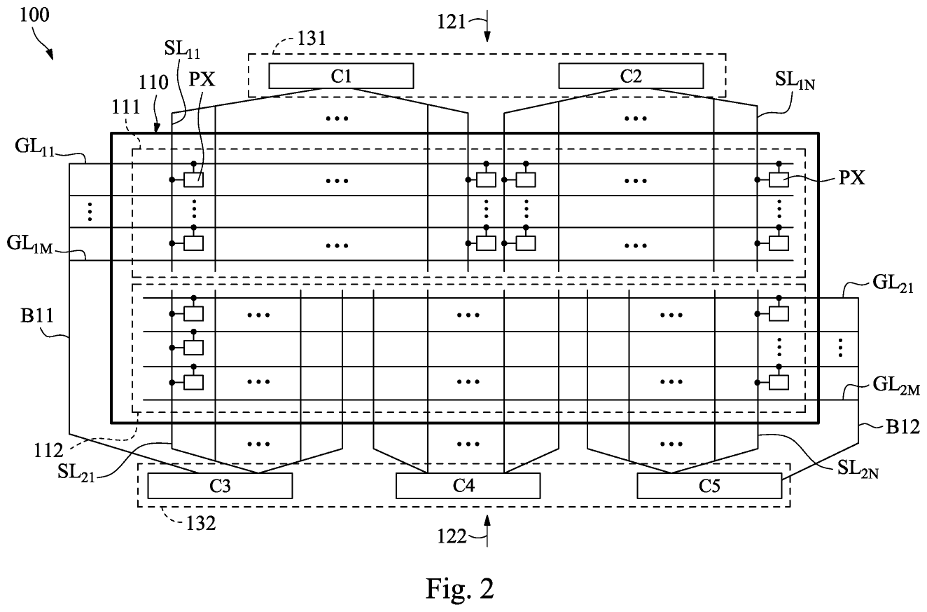

Please refer to FIG. 2. FIG. 2 is a schematic diagram illustrating a display panel 110, a first driving module 131 and a second driving module 132 in the liquid crystal display device 100 of FIG. 1. As shown in FIG. 2, the number of display blocks in the display panel 110 can be two, which are respectively a first display block 111 and a second display block 112. Regions in which the first display block 111 and the second display block 112 are located constitute an active area of the display panel 110 and have a function of displaying images. Each of the first display block 111 and the second display block 112 can be composed of a plurality of pixels PX, and the pixels PX of the first display block 111 and the second display block 112 can form a pixel array. Each of the pixels PX includes at least one display element, which has a function of displaying a specified gray scale corresponding to red, green, or blue. In some embodiments, the display panel 110 can be a cholesteric liquid crystal display (ChLCD) panel, and can further be a passive matrix liquid crystal display panel. The display element of each pixel PX can be a cholesteric liquid crystal element. For clarity, only a portion of the pixels PX are illustrated in FIG. 2 to represent all pixels PX, and other components are illustrated in a similar manner, such as data lines and scan lines described in the following paragraphs.

As further shown in FIG. 2, the number of driving modules can be two, which are respectively a first driving module 131 and a second driving module 132. The first driving module 131 and the second driving module 132 are respectively disposed on two sides of the display panel 110 (i.e., the upper side and the lower side of the display panel 110 in FIG. 2). The first driving module 131 includes two driver ICs C1, C2, and receives a timing control signal 121 from the timing control module 120. The driver ICs C1, C2 respectively output two data signal groups according to the timing control signal 121, and each of the data signal groups can include a plurality of data signals.

The second driving module 132 includes three driver ICs C3, C4, C5, and receives a timing control signal 122 from the timing control module 120. The driver ICs C3, C4, C5 respectively output three data signal groups according to the timing control signal 122, and each of the data signal groups can include a plurality of data signals. In addition, the driver IC C3 located closer to the left side of the display panel 110 can further output a scan signal group according to the timing control signal 122, and the driver IC C5 located closer to the right side of the display panel 110 can further output another scan signal group according to the timing control signal 122. Each of the scan signal groups can include a plurality of scan signals.

From top to bottom, the display panel 110 can further include a plurality of first scan lines GL₁₁-GL_{1M} corresponding to the first display block 111 and a plurality of second scan lines GL₂₁-GL_{2M} corresponding to the second display block 112, wherein M is a positive integer greater than 1. From left to right, the display panel 110 can further include a plurality of first data lines SL₁₁-SL_{1N} corresponding to the first display block 111 and a plurality of second data lines SL₂₁-SL_{2N} corresponding to the second display block 112, wherein N is a positive integer greater than 1. In some embodiments, the first scan lines GL₁₁-GL_{1M} and the second scan lines GL₂₁-GL_{2M} can be referred to as common (COM) electrodes, and the first data lines SL₁₁-SL_{1N} and the second data lines SL₂₁-SL_{2N} can be referred to as segment (SEG) electrodes. In addition, a plurality of intersections between the scan lines and the data lines can define the pixels PX in the first display block 111 and the second display block 112.

The first scan lines GL₁₁-GL_{1M} are coupled between the second driving module 132 and the first display block 111. The first scan lines GL₁₁-GL_{1M} receive a scan signal group from the second driving module 132 through a first communication bus B11, and transmit the scan signal group to the first display block 111. Specifically, the first scan lines GL₁₁-GL_{1M} first receive the scan signal group from the driver IC C3 in the second driving module 132 through the first communication bus B11, and then transmit the scan signal group to the pixels PX in the first display block 111. The second scan lines GL₂₁-GL_{2M} are coupled between the second driving module 132 and the second display block 112. The second scan lines GL₂₁-GL_{2M} receive another scan signal group from the second driving module 132 through a second communication bus B12, and transmit the another scan signal group to the second display block 112. Specifically, the second scan lines GL₂₁-GL_{2M} first receive the another scan signal group from the driver IC C5 in the second driving module 132 through the second communication bus B12, and then transmit the another scan signal group to the pixels PX in the second display block 112.

The first data lines SL₁₁-SL_{1N} are coupled between the first driving module 131 and the first display block 111. The first data lines SL₁₁-SL_{1N} receive the two data signal groups from the first driving module 131, and transmit the two data signal groups to the first display block 111. Specifically, the first data lines SL₁₁-SL_{1N} first receive the two data signal groups from the driver ICs C1, C2 in the first driving module 131, and then transmit the two data signal groups to the pixels PX in the first display block 111. The second data lines SL₂₁-SL_{2N} are coupled between the second driving module 132 and the second display block 112. The second data lines SL₂₁-SL_{2N} receive the three data signal groups from the second driving module 132, and transmit the three data signal groups to the second display block 112. Specifically, the second data lines SL₂₁-SL_{2N} first receive the three data signal groups from the driver ICs C3, C4, C5 in the second driving module 132, and then transmit the three data signal groups to the pixels PX in the second display block 112.

It should be noted that the scan signal group received by the first display block 111 from the driver IC C3 and the scan signal group received by the second display block 112 from the driver IC C5 are independent from each other. In addition, the display panel 110 of the first embodiment is divided into an upper block and a lower block, such as the first display block 111 and the second display block 112. The first display block 111 and the second display block 112 each have independent data signal groups. Accordingly, the driving signals used for imaging (i.e., the scan signals and the data signals) can be simultaneously transmitted to the first display block 111 and the second display block 112, such that the overall imaging time required for the display panel 110 to display the image is significantly reduced as compared with a conventional ChLCD having a single display block.

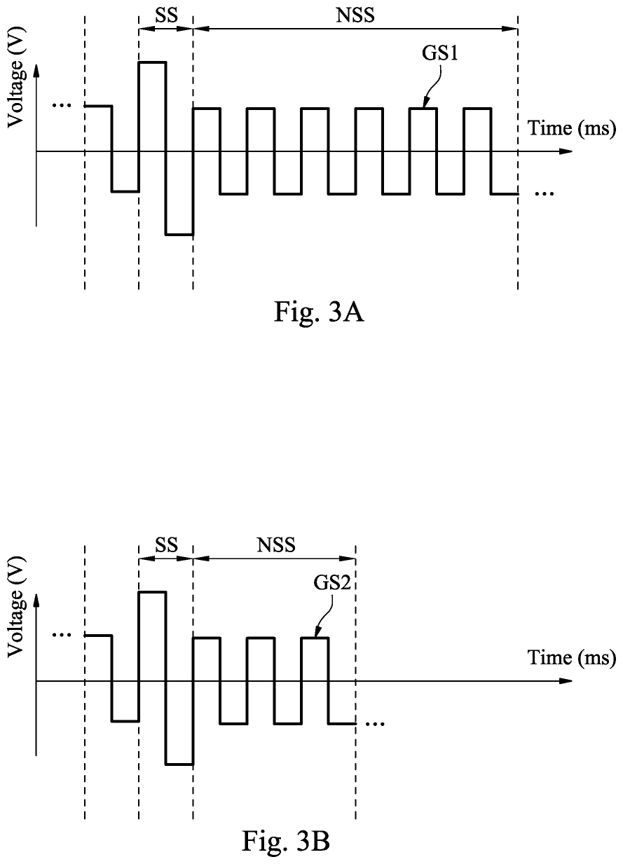

Please refer to FIGS. 3A and 3B. FIG. 3A is a timing diagram illustrating a scan signal GS1 in the conventional ChLCD. FIG. 3B is a timing diagram illustrating a scan signal GS2 in the liquid crystal display device 100 of FIG. 1. Specifically, FIG. 3A is a timing diagram illustrating pulse voltages applied to a plurality of pixels in a pixel string of a pixel array when a scanning operation (including a selection stage SS and a non-selection stage NSS) is performed on the pixel string, and FIG. 3B is similar thereto.

As shown in FIG. 3A, during the non-selection stage NSS, the scan signal GS1 is applied to non-selected scan lines six times. Taking a dynamic drive scheme (DDS) and a pulse-width modulation (PWM) drive scheme as examples, before scanning of the single display block (i.e., the entire display panel) of the conventional ChLCD is completed, the scan signal GS1 continues to be provided to non-selected pixels. Due to continuous application of energy to the cholesteric liquid crystal in the pixels, the cholesteric liquid crystal tends to undergo a certain degree of phase transition, causing the actual displayed color to deviate from the originally set color. Moreover, both the DDS and PWM drive schemes sequentially scan selected scan lines one by one, such that each scan line receives different amounts of energy during non-selection periods. Accordingly, the conventional ChLCD exhibits a certain degree of color non-uniformity. In other words, the conventional ChLCD is not divided into a plurality of display blocks (or display regions). A driver IC sequentially scans all scan lines of the entire display panel and sequentially transmits driving signals, resulting in non-uniform color performance and an increased imaging time.

As shown in FIG. 3B, during the non-selection stage NSS, the scan signal GS2 is applied to non-selected scan lines in the first display block 111 (or the second display block 112) three times, which is significantly less than that of the conventional ChLCD. Compared with the single display block of the conventional ChLCD, the number of non-selected scan lines in each of the first display block 111 and the second display block 112 is reduced. In addition, compared with the total number of scan lines in the conventional ChLCD, the total number of scan lines in each of the first display block 111 and the second display block 112 is also relatively reduced. Therefore, the number of times the scan signal GS2 is applied to non-selected scan lines is correspondingly reduced, thereby mitigating color non-uniformity. Accordingly, by dividing the display panel 110 of the liquid crystal display device 100 into an upper block and a lower block, not only can the overall imaging time be reduced, but color non-uniformity can also be avoided, such that the display panel 110 exhibits favorable imaging performance. The following paragraphs describe other examples of liquid crystal display devices 200, 300, 400, 500, 600, 700, 800 having multiple display blocks with reference to the drawings.

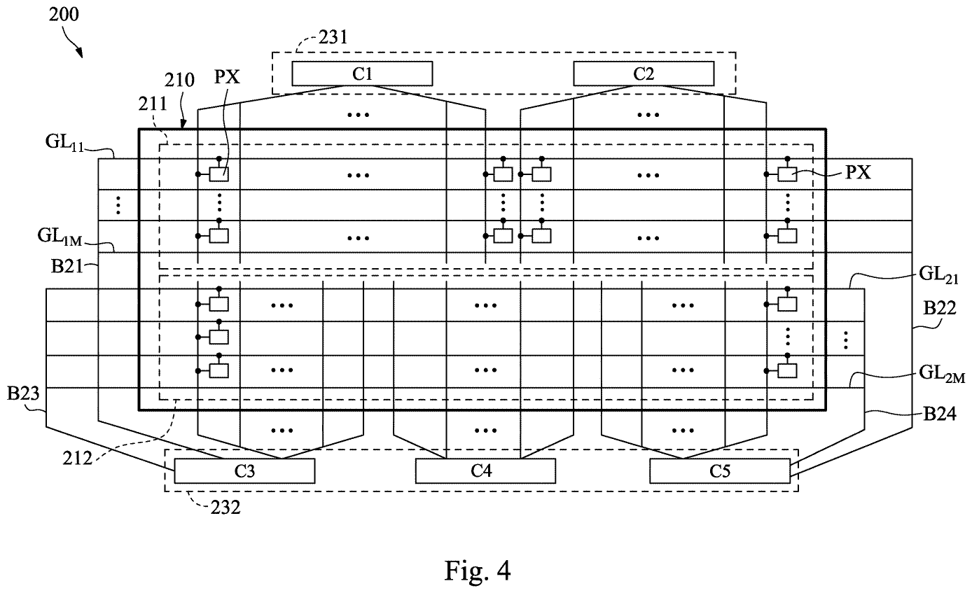

Please refer to FIG. 4. FIG. 4 is a schematic diagram illustrating a display panel 210, a first driving module 231 and a second driving module 232 of the liquid crystal display device 200 according to a second embodiment of the present disclosure. As shown in FIG. 4, the number of display blocks in the display panel 210 can be two, and the number of driving modules can also be two. The two display blocks are respectively a first display block 211 and a second display block 212, and the two driving modules are respectively a first driving module 231 and a second driving module 232. The display panel 210, the first driving module 231 and the second driving module 232 are similar to corresponding components of the liquid crystal display device 100 of the first embodiment, and thus similar internal structures and functions are not described again herein.

The difference lies in that two ends of first scan lines GL₁₁-GL_{1M} corresponding to the first display block 211 are respectively coupled to driver ICs C3, C5 in the second driving module 232 through a first communication bus B21 and a second communication bus B22. Two ends of second scan lines GL₂₁-GL_{2M} corresponding to the second display block 212 are respectively coupled to the driver ICs C3, C5 in the second driving module 232 through a third communication bus B23 and a fourth communication bus B24. Accordingly, the two ends of the first scan lines GL₁₁-GL_{1M} respectively receive corresponding scan signal groups from the driver ICs C3, C5, and transmit corresponding scan signal groups to pixels PX in the first display block 211. The two ends of the second scan lines GL₂₁-GL_{2M} respectively receive corresponding scan signal groups from the driver ICs C3, C5, and transmit corresponding scan signal groups to pixels PX in the second display block 212. In other words, the scan signal group transmitted to the first display block 211 can be generated by either one of, or jointly by, the driver ICs C3, C5 in the second driving module 232, and the same applies to the scan signal group transmitted to the second display block 212. Therefore, the liquid crystal display device 200 of the second embodiment utilizes independent data signal groups and multi-trigger scan signal groups to simultaneously, or with a slight time difference, perform multi-block driving and imaging, thereby rapidly supplying scan signals and further shortening the overall imaging time of the display panel 210.

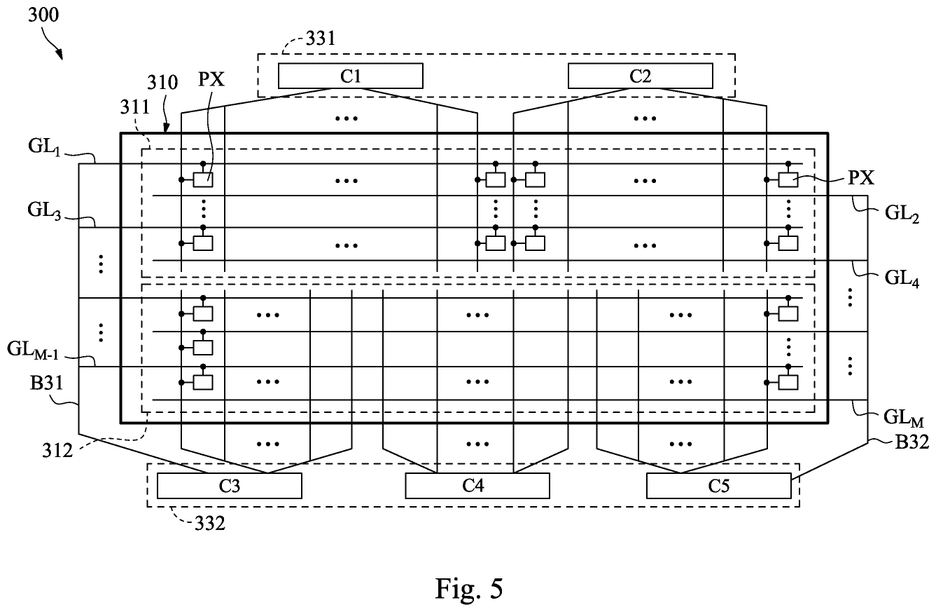

Please refer to FIG. 5. FIG. 5 is a schematic diagram illustrating a display panel 310, a first driving module 331 and a second driving module 332 of the liquid crystal display device 300 according to a third embodiment of the present disclosure. As shown in FIG. 5, the number of display blocks in the display panel 310 can be two, and the number of driving modules can also be two. The two display blocks are respectively a first display block 311 and a second display block 312, and the two driving modules are respectively a first driving module 331 and a second driving module 332. The display panel 310, the first driving module 331 and the second driving module 332 are similar to corresponding components of the liquid crystal display device 100 of the first embodiment, and thus similar internal structures and functions are not described again herein.

The difference lies in that the display panel 310 can include a plurality of scan lines coupled to pixels PX in the first display block 311 and the second display block 312. Specifically, the scan lines are sequentially labeled GL₁, GL₂, . . . , GL_{M-1}, G_{LM} from the upper side to the lower side of the display panel 310 as shown in FIG. 5, and can be grouped into a plurality of first scan lines GL₁, GL₃, . . . , GL_{M-1} and a plurality of second scan lines GL₂, GL₄, . . . , GL_{M}. The first scan lines GL₁, GL₃, . . . , GL_{M-1} and the second scan lines GL₂, GL₄, . . . , GL_{M} are alternately arranged, wherein M is a positive even integer.

One end of the first scan lines GL₁, GL₃, . . . , GL_{M-1} is coupled to a driver IC C3 in the second driving module 332 through a first communication bus B31, and the other end of the first scan lines GL₁, GL₃, . . . , GL_{M-1} is coupled to the first display block 311 and the second display block 312. The one end of the first scan lines GL₁, GL₃, . . . , GL_{M-1} receives corresponding scan signal group from the driver IC C3 and transmit corresponding scan signal group to pixels PX in the first display block 311 and the second display block 312. The one end of the second scan lines GL₂, GL₄, . . . , GL_{M} is coupled to a driver IC C5 in the second driving module 332 through a second communication bus B32, and the other end of the second scan lines GL₂, GL₄, . . . , GL_{M} is coupled to the first display block 311 and the second display block 312. The one end of the second scan lines GL₂, GL₄, . . . , GL_{M} receives corresponding scan signal group from the driver IC C5, and transmits corresponding scan signal group to pixels PX in the first display block 311 and the second display block 312. Therefore, the liquid crystal display device 300 of the third embodiment utilizes independent data signal groups and interleaved scan signals to simultaneously, or with a slight time difference, perform multi-block driving and imaging, thereby shortening the overall imaging time of the display panel 310.

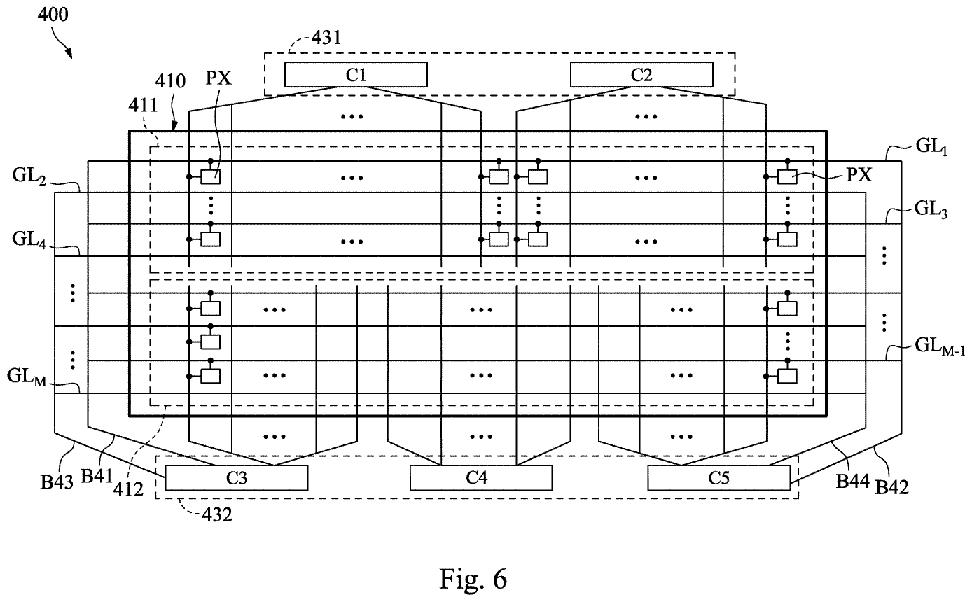

Please refer to FIG. 6. FIG. 6 is a schematic diagram illustrating a display panel 410, a first driving module 431 and a second driving module 432 of the liquid crystal display device 400 according to a fourth embodiment of the present disclosure. As shown in FIG. 6, the number of display blocks in the display panel 410 can be two, and the number of driving modules can also be two. The two display blocks are respectively a first display block 411 and a second display block 412, and the two driving modules are respectively a first driving module 431 and a second driving module 432. The display panel 410, the first driving module 431 and the second driving module 432 are similar to corresponding components of the liquid crystal display device 300 of the third embodiment, and thus similar internal structures and functions are not described again herein.

The difference lies in that two ends of the first scan lines GL₁, GL₃, . . . , GL_{M-1} are respectively coupled to the driver ICs C3, C5 in the second driving module 432 through a first communication bus B41 and a second communication bus B42. Two ends of the second scan lines GL₂, GL₄, . . . , GL_{M} are respectively coupled to the driver ICs C3, C5 in the second driving module 432 through a third communication bus B43 and a fourth communication bus B44. Accordingly, the two ends of the first scan lines GL₁, GL₃, . . . , GL_{M-1} respectively receive corresponding scan signal group from the driver ICs C3, C5 and transmit corresponding scan signal group to pixels PX in the first display block 411 and the second display block 412, and the two ends of the second scan lines GL₂, GL₄, . . . , GL_{M} respectively receive corresponding scan signal group from the driver ICs C3, C5 and transmit corresponding scan signal group to pixels PX in the first display block 411 and the second display block 412. In other words, the scan signal group transmitted to the first display block 411 and the second display block 412 through the first scan lines GL₁, GL₃, . . . , GL_{M-1} can be generated by either one of, or jointly by, the driver ICs C3, C5 in the second driving module 432, and the same applies to the scan signal group transmitted to the first display block 411 and the second display block 412 through the second scan lines GL₂, GL₄, . . . , GL_{M}. Therefore, the liquid crystal display device 400 of the fourth embodiment utilizes independent data signal groups, multi-trigger sources, and interleaved scan signal groups to simultaneously, or with a slight time difference, perform multi-block driving and imaging, thereby rapidly supplying scan signals and further shortening the overall imaging time of the display panel 410.

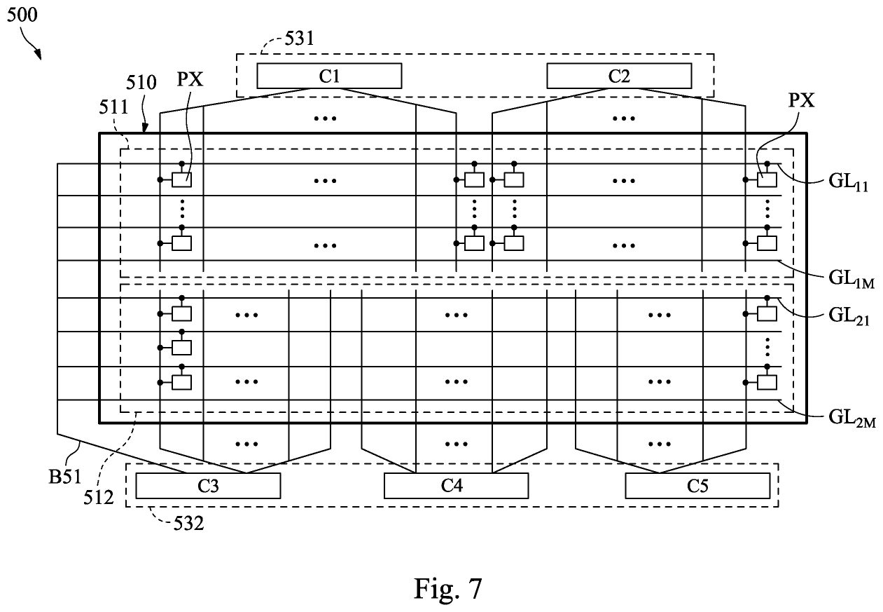

Please refer to FIG. 7. FIG. 7 is a schematic diagram illustrating a display panel 510, a first driving module 531 and a second driving module 532 of the liquid crystal display device 500 according to a fifth embodiment of the present disclosure. As shown in FIG. 7, the number of display blocks in the display panel 510 can be two, and the number of driving modules can also be two. The two display blocks are respectively a first display block 511 and a second display block 512, and the two driving modules are respectively a first driving module 531 and a second driving module 532. The display panel 510, the first driving module 531 and the second driving module 532 are similar to corresponding components of the liquid crystal display device 100 of the first embodiment, and thus similar internal structures and functions are not described again herein.

The difference lies in that the first scan lines GL₁₁-GL_{1M} are respectively connected in parallel to the second scan lines GL₂₁-GL_{2M}, and the scan signal group transmitted to the first display block 511 through the first scan lines GL₁₁-GL_{1M} is the same as the scan signal group transmitted to the second display block 512 through the second scan lines GL₂₁-GL_{2M}. Specifically, the first scan lines GL₁₁-GL_{1M} corresponding to the first display block 511 are coupled between a driver IC C3 in the second driving module 532 and the first display block 511. The first scan lines GL₁₁-GL_{1M} receive the scan signal group from the driver IC C3 through a first communication bus B51, and transmit the scan signal group to pixels PX in the first display block 511. The second scan lines GL₂₁-GL_{2M} corresponding to the second display block 512 are coupled between the driver IC C3 in the second driving module 532 and the second display block 512. The second scan lines GL₂₁-GL_{2M} receive the same scan signal group from the driver IC C3 through the first communication bus B51, and transmit the same scan signal group to pixels PX in the second display block 512. Therefore, the liquid crystal display device 500 of the fifth embodiment utilizes independent data signal groups and parallel scan signal groups to simultaneously, or with a slight time difference, perform multi-block driving and imaging, thereby shortening the overall imaging time of the display panel 510.

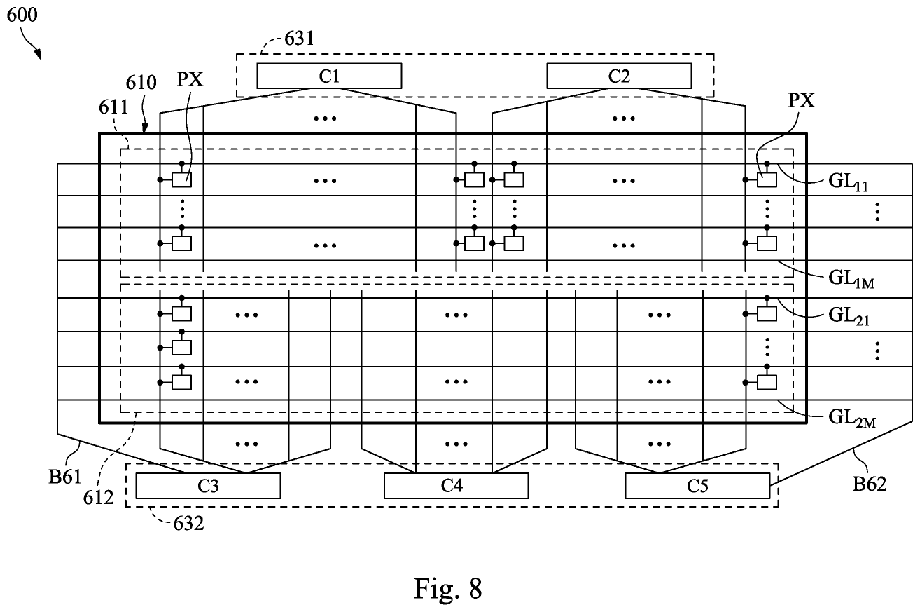

Please refer to FIG. 8. FIG. 8 is a schematic diagram illustrating a display panel 610, a first driving module 631 and a second driving module 632 of the liquid crystal display device 600 according to a sixth embodiment of the present disclosure. As shown in FIG. 8, the number of display blocks in the display panel 610 can be two, and the number of driving modules can also be two. The two display blocks can be respectively a first display block 611 and a second display block 612, and the two driving modules can be respectively a first driving module 631 and a second driving module 632. The display panel 610, the first driving module 631 and the second driving module 632 are similar to the corresponding components of the liquid crystal display device 500 of the fifth embodiment, and thus similar internal structures and functions are not described again herein.

The difference lies in that two ends of the first scan lines GL₁₁-GL_{1M} corresponding to the first display block 611 are respectively coupled to the driver ICs C3, C5 in the second driving module 632 through a first communication bus B61 and a second communication bus B62. Similarly, two ends of the second scan lines GL₂₁-GL_{2M} corresponding to the second display block 612 are respectively coupled to the driver ICs C3, C5 in the second driving module 632 through the first communication bus B61 and the second communication bus B62. Accordingly, the two ends of the first scan lines GL₁₁-GL_{1M} respectively receive the scan signal group from the driver ICs C3, C5, and transmit the scan signal group to pixels PX in the first display block 611. The two ends of the second scan lines GL₂₁-GL_{2M} respectively receive the same scan signal group from the driver ICs C3, C5, and transmit the same scan signal group to pixels PX in the second display block 612. In other words, the scan signal groups transmitted simultaneously to the first display block 611 and the second display block 612 can be generated by either one of, or jointly by, the driver ICs C3, C5 in the second driving module 632. Therefore, the liquid crystal display device 600 of the sixth embodiment utilizes independent data signal groups, multi-trigger sources, and parallel scan signal groups to simultaneously, or with a slight time difference, perform multi-block driving and imaging, thereby rapidly supplying scan signals and further shortening the overall imaging time of the display panel 610.

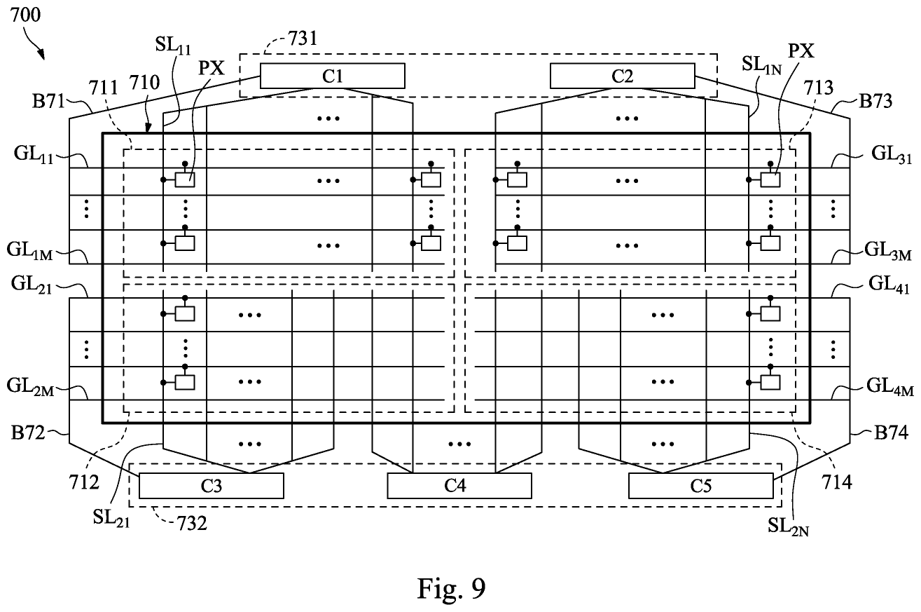

Please refer to FIG. 9. FIG. 9 is a schematic diagram illustrating a display panel 710, a first driving module 731 and a second driving module 732 of the liquid crystal display device 700 according to a seventh embodiment of the present disclosure. As shown in FIG. 9, the liquid crystal display device 700 includes a display panel 710 and a plurality of driving modules. The number of the driving modules can be two, which can be respectively a first driving module 731 and a second driving module 732. The display panel 710, the first driving module 731 and the second driving module 732 are similar to the corresponding components of the liquid crystal display device 100 of the first embodiment, and thus similar internal structures and functions are not described again herein.

The difference lies in that the number of display blocks in the display panel 710 can be four. The four display blocks can be respectively a first display block 711, a second display block 712, a third display block 713 and a fourth display block 714. In addition, the display panel 710 can include a plurality of first scan lines GL₁₁-GL_{1M} corresponding to the first display block 711, a plurality of second scan lines GL₂₁-GL_{2M} corresponding to the second display block 712, a plurality of third scan lines GL₃₁-GL_{3M} corresponding to the third display block 713, and a plurality of fourth scan lines GL₄₁-GL_{4M} corresponding to the fourth display block 714, wherein M is a positive integer greater than 1. Furthermore, the display panel 710 can further include a plurality of first data lines SL₁₁-SL_{1N} corresponding to the first display block 711 and a plurality of second data lines SL₂₁-SL_{2N} corresponding to the second display block 712, wherein N is a positive integer greater than 1.

The first scan lines GL₁₁-GL_{1M} are coupled between a driver IC C1 in the first driving module 731 and the first display block 711. The first scan lines GL₁₁-GL_{1M} receive corresponding scan signal group from the driver IC C1 through a first communication bus B71, and transmit corresponding scan signal group to pixels PX in the first display block 711.

The second scan lines GL₂₁-GL_{2M} are coupled between a driver IC C3 in the second driving module 732 and the second display block 712. The second scan lines GL₂₁-GL_{2M} receive corresponding scan signal group from the driver IC C3 through a second communication bus B72, and transmit corresponding scan signal group to pixels PX in the second display block 712.

The third scan lines GL₃₁-GL_{3M} are coupled between a driver IC C2 in the first driving module 731 and the third display block 713. The third scan lines GL₃₁-GL_{3M} receive corresponding scan signal group from the driver IC C2 through a third communication bus B73, and transmit corresponding scan signal group to pixels PX in the third display block 713.

The fourth scan lines GL₄₁-GL_{4M} are coupled between a driver IC C5 in the second driving module 732 and the fourth display block 714. The fourth scan lines GL₄₁-GL_{4M} receive corresponding scan signal group from the driver IC C5 through a fourth communication bus B74, and transmit corresponding scan signal group to pixels PX in the fourth display block 714.

A portion of the first data lines SL₁₁-SL_{1N} is coupled between the driver IC C1 in the first driving module 731 and the first display block 711. The portion of the first data lines SL₁₁-SL_{1N} receives corresponding data signal group from the driver IC C1, and transmits corresponding data signal group to the pixels PX in the first display block 711. Another portion of the first data lines SL₁₁-SL_{1N} is coupled between the driver IC C2 in the first driving module 731 and the third display block 713. The another portion of the first data lines SL₁₁-SL_{1N} receives corresponding data signal group from the driver IC C2, and transmits corresponding data signal group to pixels PX in the third display block 713.

A portion of the second data lines SL₂₁-SL_{2N} is coupled between the driver ICs C3, C4 in the second driving module 732 and the second display block 712. The portion of the second data lines SL₂₁-SL_{2N} receives corresponding data signal group from the driver ICs C3, C4, and transmits corresponding data signal group to the pixels PX in the second display block 712. Another portion of the second data lines SL₂₁-SL_{2N} is coupled between the driver ICs C4, C5 in the second driving module 732 and the fourth display block 714. The another portion of the second data lines SL₂₁-SL_{2N} receives corresponding data signal group from the driver ICs C4, C5, and transmits corresponding data signal group to the pixels PX in the fourth display block 714.

The plurality of scan signal groups received by the first display block 711, the second display block 712, the third display block 713 and the fourth display block 714 are independent from one another, and each of the four display blocks further has an independent data signal group. Therefore, compared with the foregoing embodiments, the liquid crystal display device 700 of the seventh embodiment divides the display panel 710 into more blocks and utilizes independent data signal groups and independent scan signal groups to simultaneously, or with a slight time difference, perform multi-block driving and imaging, thereby further shortening the overall imaging time of the display panel 710.

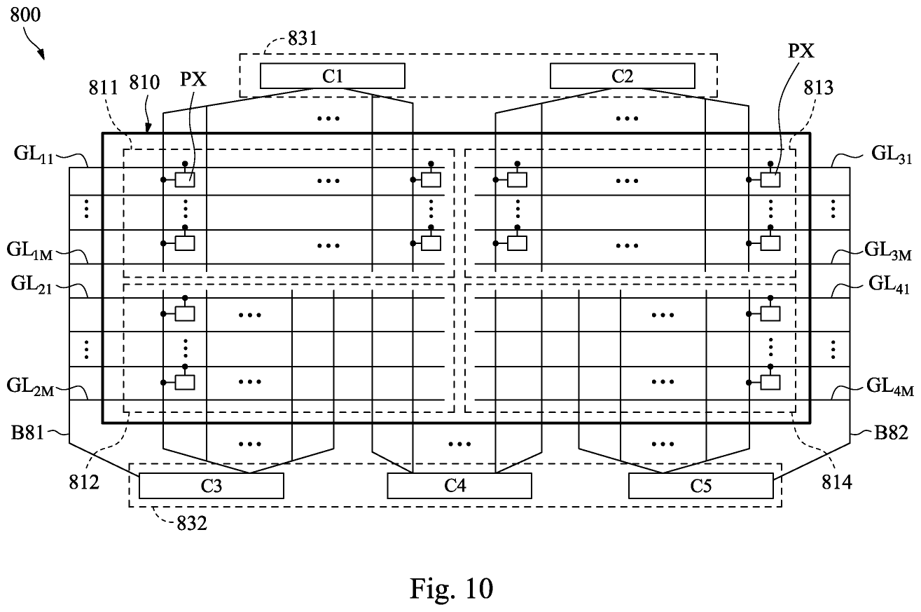

Please refer to FIG. 10. FIG. 10 is a schematic diagram illustrating a display panel 810, a first driving module 831 and a second driving module 832 of the liquid crystal display device 800 according to an eighth embodiment of the present disclosure. As shown in FIG. 10, the number of display blocks in the display panel 810 can be four, and the number of driving modules can be two. The four display blocks can be respectively a first display block 811, a second display block 812, a third display block 813 and a fourth display block 814, and the two driving modules can be respectively a first driving module 831 and a second driving module 832. The display panel 810, the first driving module 831 and the second driving module 832 are similar to the corresponding components of the liquid crystal display device 700 of the seventh embodiment, and thus similar internal structures and functions are not described again herein.

The difference lies in that the first scan lines GL₁₁-GL_{1M} corresponding to the first display block 811 and the second scan lines GL₂₁-GL_{2M} corresponding to the second display block 812 are both coupled to a driver IC C3 in the second driving module 832 through a first communication bus B81. The third scan lines GL₃₁-GL_{3M} corresponding to the third display block 813 and the fourth scan lines GL₄₁-GL_{4M} corresponding to the fourth display block 814 are both coupled to a driver IC C5 in the second driving module 832 through a second communication bus B82.

Accordingly, the first scan lines GL₁₁-GL_{1M} and the second scan lines GL₂₁-GL_{2M} can both receive the same scan signal group from the driver IC C3, and respectively transmit the same scan signal group to pixels PX in the first display block 811 and the second display block 812. Similarly, the third scan lines GL₃₁-GL_{3M} and the fourth scan lines GL₄₁-GL_{4M} can both receive the same scan signal group from the driver IC C5, and respectively transmit the same scan signal group to pixels PX in the third display block 813 and the fourth display block 814. Therefore, the liquid crystal display device 800 of the eighth embodiment utilizes independent data signal groups and dual-driver parallel scan signal groups to simultaneously, or with a slight time difference, perform multi-block driving and imaging, thereby rapidly supplying scan signals and further shortening the overall imaging time of the display panel 810.

The following description merely illustrates, by way of example, a driving method 900 of a liquid crystal display device (hereinafter referred to as the driving method 900) applied to the liquid crystal display device 100 of the first embodiment. However, in other embodiments, the driving method 900 can also be applied to the liquid crystal display devices 200, 300, 400, 500, 600, 700, 800 of the second through eighth embodiments.

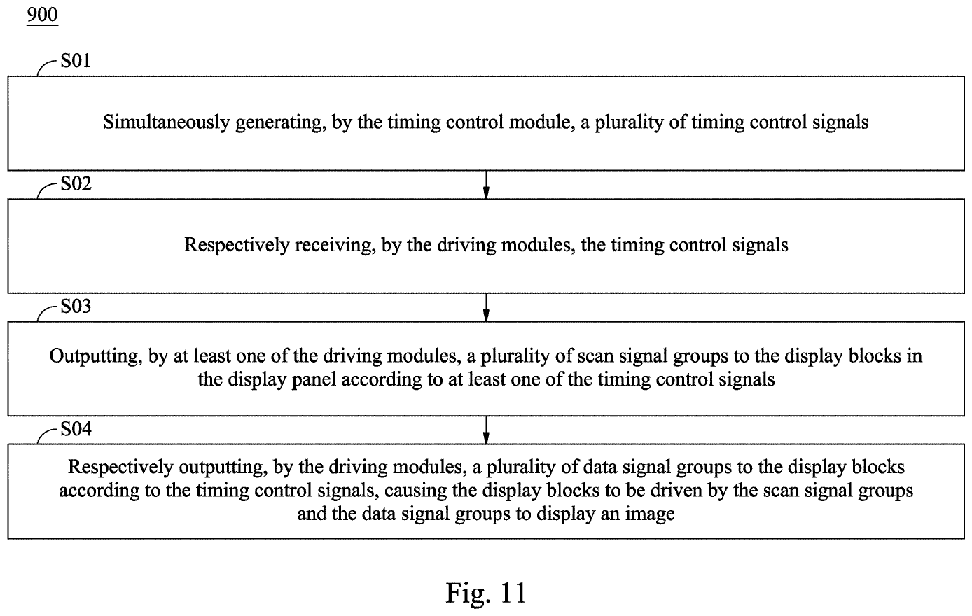

Please refer to FIGS. 1, 2 and 11. FIG. 11 is a flowchart illustrating the driving method 900 of a liquid crystal display device according to a ninth embodiment of the present disclosure. As shown in FIGS. 1, 2 and 11, the driving method 900 can be used to drive the liquid crystal display device 100, and includes the following Steps S01, S02, S03, S04.

Step S01 involves simultaneously generating, by the timing control module 120, a plurality of timing control signals 121, 122.

Step S02 involves respectively receiving, by the driving modules (i.e., the first driving module 131 and the second driving module 132), the timing control signals 121, 122.

Step S03 involves outputting, by at least one of the driving modules (e.g., the second driving module 132), a plurality of scan signal groups to the display blocks (i.e., the first display block 111 and the second display block 112) in the display panel 110 according to at least one of the timing control signals 121, 122 (e.g., the timing control signal 122).

Step S04 involves respectively outputting, by the driving modules (i.e., the first driving module 131 and the second driving module 132), a plurality of data signal groups to the display blocks (i.e., the first display block 111 and the second display block 112) according to the timing control signals 121, 122, causing the display blocks to be driven by the scan signal groups and the data signal groups to display an image.

In summary, the liquid crystal display device and the driving method thereof of the present disclosure have the following advantages. First, the display panel is divided into a plurality of display blocks for driving and imaging, and driving signal sources on the display panel can be divided into a plurality of groups, thereby enabling multi-block driving and imaging to be performed simultaneously or with a slight time difference so as to reduce imaging time and achieve a shorter imaging time. Second, parallel scan signal groups can be uniformly provided by the same driver IC. Compared with independently controlled scan signal groups, adopting parallel scan signal groups allows the display panel to use fewer signal lines, thereby reducing channel usage of the driver IC. Third, in addition to reducing the overall imaging time by using independent scan signal groups, interleaved scan signals, or parallel scan signal groups together with independent data signal groups, image color non-uniformity can also be avoided, thereby enabling the display panel to have favorable imaging quality.

Although the present disclosure has been described in considerable detail with reference to certain embodiments thereof, other embodiments are possible. Therefore, the spirit and scope of the appended claims should not be limited to the description of the embodiments contained herein.

What is claimed is:

1. A liquid crystal display device, comprising:
a display panel, comprising a plurality of display blocks;
a timing control module, configured to simultaneously generate a plurality of timing control signals; and
a plurality of driving modules, connected between the timing control module and the display panel and respectively receiving the timing control signals;
wherein at least one of the driving modules outputs a plurality of scan signal groups to the display blocks according to at least one of the timing control signals;
wherein the driving modules respectively output a plurality of data signal groups to the display blocks according to the timing control signals, causing the display blocks to be driven by the scan signal groups and the data signal groups to display an image.

2. The liquid crystal display device of claim 1, wherein the driving modules are a first driving module and a second driving module, the display blocks are a first display block and a second display block, and the display panel further comprises:
a plurality of first scan lines, coupled between the second driving module and the first display block, wherein the first scan lines receive one of the scan signal groups from the second driving module and transmit the one of the scan signal groups to the first display block;
a plurality of second scan lines, coupled between the second driving module and the second display block, wherein the second scan lines receive another of the scan signal groups from the second driving module and transmit the another of the scan signal groups to the second display block;
a plurality of first data lines, coupled between the first driving module and the first display block, wherein the first data lines receive at least one of the data signal groups from the first driving module and transmit the at least one of the data signal groups to the first display block; and
a plurality of second data lines, coupled between the second driving module and the second display block, wherein the second data lines receive at least another of the data signal groups from the second driving module and transmit the at least another of the data signal groups to the second display block;
wherein the one of the scan signal groups and the another of the scan signal groups are independent from each other.

3. The liquid crystal display device of claim 1, wherein the driving modules are a first driving module and a second driving module, the display blocks are a first display block and a second display block, and the display panel further comprises:
a plurality of first scan lines, coupled to the second driving module, the first display block, and the second display block, wherein the first scan lines receive one of the scan signal groups from the second driving module and transmit the one of the scan signal groups to the first display block and the second display block;
a plurality of second scan lines, coupled to the second driving module, the first display block, and the second display block, wherein the second scan lines receive another of the scan signal groups from the second driving module and transmit the another of the scan signal groups to the first display block and the second display block;
a plurality of first data lines, coupled between the first driving module and the first display block, wherein the first data lines receive at least one of the data signal groups from the first driving module and transmit the at least one of the data signal groups to the first display block; and
a plurality of second data lines, coupled between the second driving module and the second display block, wherein the second data lines receive at least another of the data signal groups from the second driving module and transmit the at least another of the data signal groups to the second display block;
wherein the first scan lines and the second scan lines are alternately arranged.

4. The liquid crystal display device of claim 1, wherein the driving modules are a first driving module and a second driving module, the display blocks are a first display block and a second display block, and the display panel further comprises:
a plurality of first scan lines, coupled between the second driving module and the first display block, wherein the first scan lines receive one of the scan signal groups from the second driving module and transmit the one of the scan signal groups to the first display block;
a plurality of second scan lines, coupled between the second driving module and the second display block, wherein the second scan lines receive another of the scan signal groups from the second driving module and transmit the another of the scan signal groups to the second display block;
a plurality of first data lines, coupled between the first driving module and the first display block, wherein the first data lines receive at least one of the data signal groups from the first driving module and transmit the at least one of the data signal groups to the first display block; and
a plurality of second data lines, coupled between the second driving module and the second display block, wherein the second data lines receive at least another of the data signal groups from the second driving module and transmit the at least another of the data signal groups to the second display block;
wherein the first scan lines are connected in parallel to the second scan lines, and the one of the scan signal groups is the same as the another of the scan signal groups.

5. The liquid crystal display device of claim 1, wherein each of the driving modules comprises a plurality of driver integrated circuits, and one of the scan signal groups is generated by any one of the driver integrated circuits of the at least one of the driving modules.

6. The liquid crystal display device of claim 1, wherein the display panel is a passive matrix liquid crystal display panel.

7. The liquid crystal display device of claim 1, wherein the display panel is a cholesteric liquid crystal display panel.

8. A driving method of a liquid crystal display device, for driving the liquid crystal display device, the liquid crystal display device comprising a display panel, a timing control module, and a plurality of driving modules, the display panel comprising a plurality of display blocks, and the driving method of the liquid crystal display device comprising:
simultaneously generating, by the timing control module, a plurality of timing control signals;
respectively receiving, by the driving modules, the timing control signals;
outputting, by at least one of the driving modules, a plurality of scan signal groups to the display blocks according to at least one of the timing control signals; and
respectively outputting, by the driving modules, a plurality of data signal groups to the display blocks according to the timing control signals, causing the display blocks to be driven by the scan signal groups and the data signal groups to display an image.

9. The driving method of the liquid crystal display device of claim 8, wherein the driving modules are a first driving module and a second driving module, the display blocks are a first display block and a second display block, and the display panel further comprises:
a plurality of first scan lines, configured to receive one of the scan signal groups from the second driving module and transmit the one of the scan signal groups to the first display block;
a plurality of second scan lines, configured to receive another of the scan signal groups from the second driving module and transmit the another of the scan signal groups to the second display block;
a plurality of first data lines, configured to receive at least one of the data signal groups from the first driving module and transmit the at least one of the data signal groups to the first display block; and
a plurality of second data lines, configured to receive at least another of the data signal groups from the second driving module and transmit the at least another of the data signal groups to the second display block;
wherein the one of the scan signal groups and the another of the scan signal groups are independent from each other.

10. The driving method of the liquid crystal display device of claim 8, wherein the driving modules are a first driving module and a second driving module, the display blocks are a first display block and a second display block, and the display panel further comprises:
a plurality of first scan lines, configured to receive one of the scan signal groups from the second driving module and transmit the one of the scan signal groups to the first display block and the second display block;
a plurality of second scan lines, configured to receive another of the scan signal groups from the second driving module and transmit the another of the scan signal groups to the first display block and the second display block;
a plurality of first data lines, configured to receive at least one of the data signal groups from the first driving module and transmit the at least one of the data signal groups to the first display block; and
a plurality of second data lines, configured to receive at least another of the data signal groups from the second driving module and transmit the at least another of the data signal groups to the second display block;
wherein the first scan lines and the second scan lines are alternately arranged.

11. The driving method of the liquid crystal display device of claim 8, wherein the driving modules are a first driving module and a second driving module, the display blocks are a first display block and a second display block, and the display panel further comprises:
a plurality of first scan lines, configured to receive one of the scan signal groups from the second driving module and transmit the one of the scan signal groups to the first display block;
a plurality of second scan lines, configured to receive another of the scan signal groups from the second driving module and transmit the another of the scan signal groups to the second display block;
a plurality of first data lines, configured to receive at least one of the data signal groups from the first driving module and transmit the at least one of the data signal groups to the first display block; and
a plurality of second data lines, configured to receive at least another of the data signal groups from the second driving module and transmit the at least another of the data signal groups to the second display block;
wherein the first scan lines are connected in parallel to the second scan lines, and the one of the scan signal groups is the same as the another of the scan signal groups.

12. The driving method of the liquid crystal display device of claim 8, wherein each of the driving modules comprises a plurality of driver integrated circuits, and one of the scan signal groups is generated by any one of the driver integrated circuits of the at least one of the driving modules.

13. The driving method of the liquid crystal display device of claim 8, wherein the display panel is a passive matrix liquid crystal display panel.

14. The driving method of the liquid crystal display device of claim 8, wherein the display panel is a cholesteric liquid crystal display panel.
